(19) United States
(12) Patent Application Publication
(10) Pub. No.: US 2003/0128890 A1
(43) Pub. Date: Jul. 10, 2003

(54) Method of forming different images of an object to be examined

(76) Inventors: Peter Roesch, Hamburg (DE); Joern Borgert, Hamburg (DE)

Correspondence Address: PHILIPS ELECTRONICS NORTH AMERICAN CORP, 580 WHITE PLAINS RD, TARRYTOWN, NY, 10591, US

(21) Appl. No.: 10/323,417

(22) Filed: Dec. 19, 2002

(30) Foreign Application Priority Data
Dec. 22, 2001 (DE) 10163813.2

(51) Int. Cl. G06K 9/32; G06K 9/00; G06K 9/36

(52) U.S. Cl. 382/276; 382/131; 382/294

(57) ABSTRACT

The invention relates to a method of forming different images of an object to be examined, notably medical images of a patient, which method includes the steps of:

displaying at least one first image and one second image,

determining an elastic transformation which associates image elements of the first image with respective image elements of the second image,

defining an object which is superposed on the first image and displayed together with the first image,

determining, using the elastic transformation, an object in the second image which corresponds to the object in the first image,

superposing the corresponding object on the second image, and

displaying the corresponding object together with the second image.

The present invention relates to a method and a device for forming different images of an object to be examined as well as to a computer program for carrying out the method.

In the field of medical diagnostics it is often necessary to recognize changes of the object to be examined on the basis of different images of the same object. Images formed at different instants by means of computed tomography or magnetic resonance tomography, however, generally have been acquired from different positions and viewing directions. Furthermore, natural motions of the patient are a cause that the position and the shape of the organs differ in the different images. The bending of joints and the respiratory motion constitutes flexible or non-rigid motions, meaning that the anatomical object to be examined cannot be shifted to its original position by rigid transformations such as rotation and translation.

It is often desired that the images acquired at different instants should enable the physician to recognize which of the changes appearing in the imaged object are due to natural motions and deformations and which changes can be attributed to pathological changes such as, for example, tumor growth. Images of a patient which have been formed before and after an operation or treatment are routinely compared so as to assess the result of the treatment.

The physician has the difficult task of distinguishing differences between the images which are due to natural patient motions from pathological changes or changes which are due to an operation. In doing so the physician is customarily assisted by imaging methods which register the images to be compared. Elastic transformations are used for this purpose, because deformations of the object to be examined do not represent rigid motions in many cases. A variety of methods are known for determining the parameters specifying the elastic transformations, for example, from the publication by P. Rosch, T. Netsch, M. Quist, G. P. Penney, D. L. G. Hill and J. Weese: “Robust 3 D deformation field estimation by template propagation”, Vol. 1935, pp. 521 to 530, MICCAI, Springer, 2000.

Suitable interpolation methods, for example, as described in the publication by M. Fomefett, K. Rohr, and S. Stiehl: “Radial base functions with compact support for elastic registration of medical images”, Image and Vision Computing, 19: 87-96, 2001, are used to obtain dense transformation fields from the parameters determined. The image or deformation field thus obtained is applied to one of the images so as to calculate the result of the transformation. The transformed image and the corresponding original image can be displayed adjacent one another, or the differences between the two images are visualized by means of subtraction or superposition methods.

The application of elastic transformations, however, has a number of drawbacks. On the one hand, the use of interpolation methods gives rise to blurred or unsharp edges of the transformed image. On the other hand, inaccuracies of the elastic transformation determined give rise to artifacts. Artifacts of this kind lead to significant changes of the shape of the visualized anatomical structures.

However, the most important problem is the following: the methods used for determining an elastic transformation do not discriminate between pathological changes (for example, due to growth of a tumor) and natural deformations of the object to be examined (for example, due to patient motion). Therefore, all customarily applied algorithms tend to correct for pathological as well as non-pathological changes of the visualized object to be examined. This means that the differences between the original image and the transformed image do not allow any conclusions to be drawn as regards the pathological changes or changes which are due to an operation. The transformed image is not suitable for making a diagnosis, which is why radiologists insist on viewing and interpreting the original images. Consequently, the use of elastic transformations for the visualization of image changes thus far has not become common practice in the clinical domain.

It is an object of the present invention to provide a method of forming different images of an object to be examined which mitigates the described drawbacks and notably enables the use of elastic transformations for clinical diagnostics.

This object is achieved in accordance with the invention by means of a method of forming different images of an object to be examined, which method includes the following steps:

displaying at least one first image and one second image of objects to be examined,

determining an elastic transformation which associates image elements of the first image with respective image elements of the second image,

defining an object which is superposed on the first image and displayed together with the first image,

determining, using the elastic transformation, an object in the second image which corresponds to the object in the first image,

superposing the corresponding object on the second image, and

displaying the corresponding object together with the second image.

In accordance with the invention the images originally acquired are displayed without any modifications. Thus, a viewer can independently assess the differences in the visualized anatomy in the same way as before. However, in doing so the viewer is assisted by the method in accordance with the invention. To this end, the viewer selects an image element of interest, for example, a tumor or an anatomical element in the first image, in that the viewer identifies an object which is superposed on the first image. Surfaces, contours or lines, but also individual points, that is, so-called landmarks, are suitable objects in this respect. The object is shown to the viewer in the first image. For example, the object is given a uniform color which makes the object clearly distinct from the first image.

The corresponding object in the second image is determined by means of the elastic transformation. The elastic transformation represents a mapping rule which associates the image elements of the first image with respective image elements of the second image. The image contents, notably the color shades, gray values and brightness levels of the first image, are not modified by the elastic transformation. The elastic transformation only associates the position of an image point in the first image with a corresponding position in the second image. The elastic transformation determines the corresponding object in the second image on the basis of the sub-region of the first image on which the defined object is superposed. The original second image is still displayed in unmodified form, except for the corresponding object. The viewer can independently assess whether the anatomy visualized in the images has changed. The result of the elastic transformation, being shown in the second image, thus serves as an aid in assessing the displayed images.

Preferably, each time three first and three second images are displayed, the first and second images representing each time three different, preferably mutually orthogonal sectional planes of an object to be examined. The first images represent, for example, the state of an object to be examined at an instant other than that of the second images. However, they may also be images of different objects to be examined. The first and second images offer the viewer an impression of the three-dimensional configuration of the displayed object to be examined. Preferably, an object defined in one of the three first images is represented each time in the other first images. Thus, ultimately a three-dimensional object corresponding, for example, to a region of interest of the anatomical object to be examined can be defined. The elastic transformation associates the image elements of the first three images each time with respective image elements of the second three images. The method in accordance with the invention is preferably conceived in such a way that, when the object in one of the first images changes, all representations of the object in all other first and second images are changed directly and automatically.

The first and second images often represent the object to be examined from different orientations. The comparison of the displayed images by the viewer can be supported by displaying the object to be examined in the first and second images from corresponding orientations. To this end, for example, the observer selects several points or landmarks in the first images. Subsequently, a plane or surface is calculated in which all landmarks are situated. When the landmarks are not situated in one plane or surface, a surface is calculated whose Euclidean distance from the landmarks is minimum. Preferably, flat planes or surfaces are calculated. However, it is also possible to calculate curved planes or surfaces at the smallest distance from the landmarks. Subsequently, using the elastic transformation, the corresponding plane or surface is calculated for the second images. The calculated planes or surfaces in the first and the second image represent the respective viewing plane to be used in which the objects to be examined are reproduced. From the acquired image data it is calculated how the object to be examined appears in the calculated planes or surfaces displayed to the viewer.

Preferably, the selected object in the first image represents an edge of a three-dimensional object. An edge can be defined, for example, as the representation of a tumor surface in the first image. The corresponding object of the second image then represents the edge of the tumor calculated by the elastic transformation at the instant of acquisition of the second image, in as far as the tumor has not changed in the mean time. Because the calculated surface is displayed so as to be superposed on the original second image, the radiologist can determine immediately whether the tumor has changed or not. This is because if the tumor has changed, the (calculated) edge superposed on the second image in a preferred embodiment does not register with the actual edge of the tumor in the second image. The diagnosis is not taken way from the radiologist, but the radiologist is merely assisted in making a diagnosis.

It may also be arranged that the size and position of the object are also changed by the elastic transformation, that is, in a sense that the image contents superposed on the object differ in respect of size and position between the first and the second image, for example, when a tumor enclosed by the object has shrunk or grown in the mean time. The object will be changed in this manner notably if changes of the superposed image contents were taken into account for the determination of the elastic transformation rule. Thus, when an enclosed tumor is reproduced in the first images and the size of the tumor has changed before the formation of the second images, in this version the edge of the tumor in the second images will be correctly marked again by the corresponding object, thus enabling direct comparison of the tumor in the images by the physician.

The object in the first image or in the first images is preferably selected manually. The selection of the object can be realized by way of a model-based segmentation method. Deformable model regions are then used. To this end, the deformable model region can be placed, for example, in a suitable position in the first image so as to be deformed subsequently. The corresponding object, displayed in the second image, does not always correctly represent the change of the object defined in the first image, that is, due to inaccuracies and artifacts of the elastic transformation. Therefore, it is preferably possible to perform a manual correction of the corresponding object in the second image; however, automatic or semi-automatic correction may also be provided.

The first image is preferably forms an image of a standardized model of an object to be examined while the second image is preferably an image of the object to be examined. This method is particularly suitable for use for the testing of materials. For example, the model of a correctly manufactured component can be visualized as the first image. The second image represents the component to be tested. Differences between the corresponding object in the second image and the object in the first image then reveal deviations of the component to be tested from the correctly manufactured component.

The invention proposes a device for forming different images of an object to be examined. The device in accordance with the invention includes a display means, definition means for defining objects, and an arithmetic unit. The display means is arranged for simultaneous display of the first and second images of the object to be examined. The definition means serve to enable the radiologist or viewer to define objects in the first image. The selected object is subsequently displayed by the display means in the first image. The arithmetic unit is provided so as to determine the elastic transformation which associates the image elements of the first image with respective image elements of the second image. It also calculates the corresponding object from the selected object, said corresponding object ultimately being visualized in the second image by the display means.

A preferred embodiment of the present invention will be described in detail hereinafter with reference to the associated Figures. Therein:

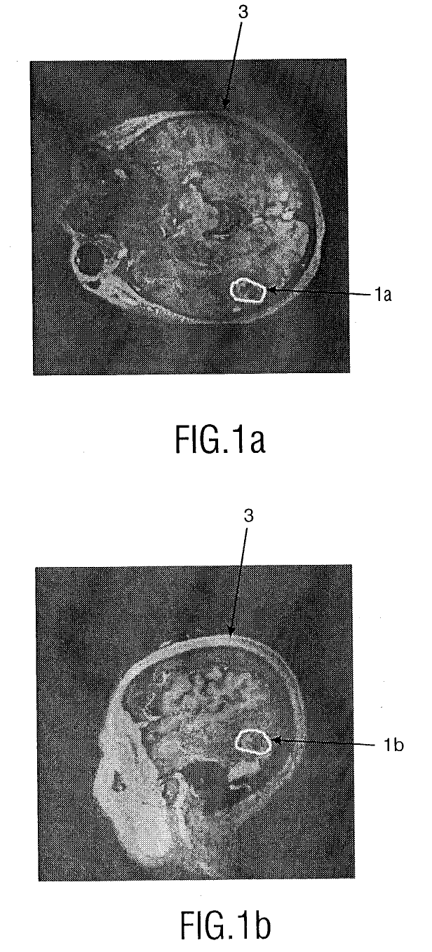

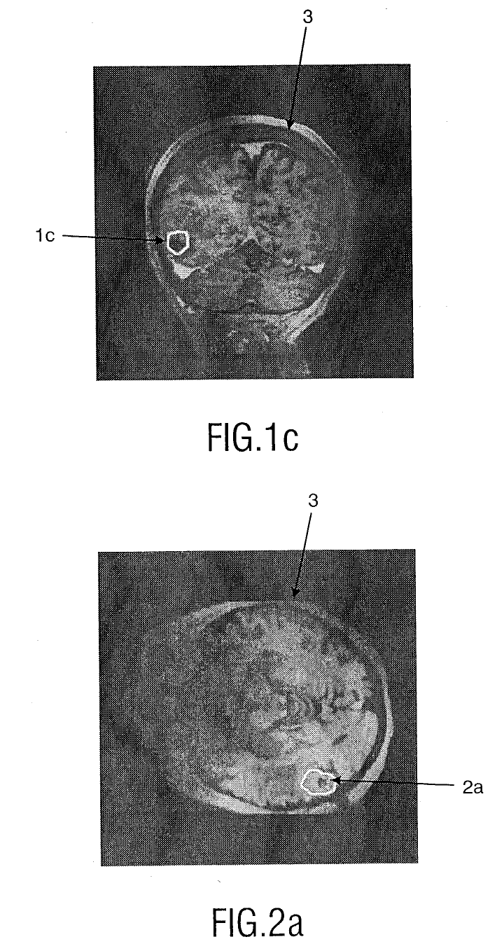

FIGS. 1a, 1b and 1c show three first orthogonal sectional images of a head,

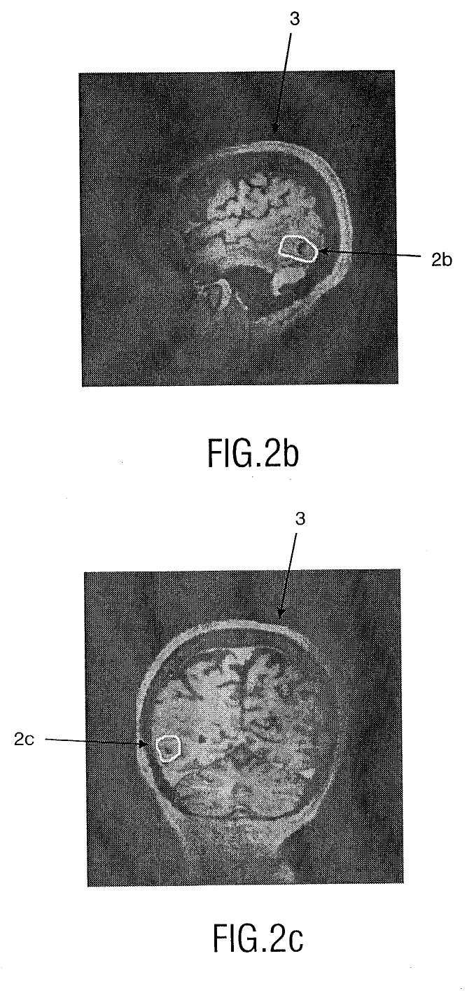

FIGS. 2a, 2b and 2c show three second orthogonal sectional images of the same head, and

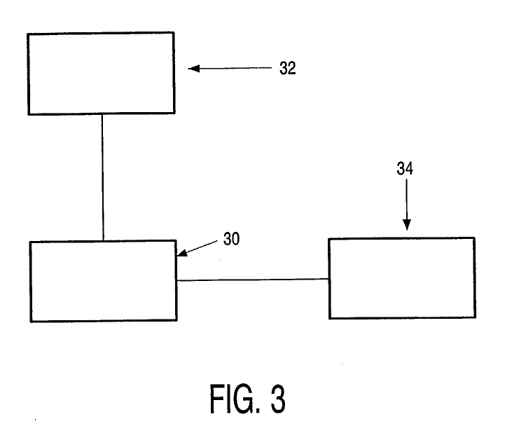

FIG. 3 shows a device in accordance with the invention for the simultaneous display of the images shown in the FIGS. 1 and 2.

The sectional images of a head 3 of a patient as shown in the FIGS. 1a to 1c and 2a to 2c are simultaneously displayed to the radiologist. They represent a magnetic resonance image of a patient suffering from a tumor. The images taken up in the FIGS. 2a to 2c were acquired after extraction and examination of a specimen of the tissue of the tumor. In order to enable assessment of any intermediate change of the tumor tissue, the radiologist must be capable of identifying the tumor tissue in the various images. This assessment is supported by the method in accordance with the invention.

In the device shown in FIG. 3 an arithmetic unit 30 is connected to a display means 32, for example, a display screen, which displays the images shown in the FIGS. 1 and 2. The arithmetic unit 30 calculates an elastic transformation which maps the images shown in the FIGS. 1a, 1b and 1c on the images shown in the FIGS. 2a, 2b and 2c. The image points or image elements shown in the FIGS. 1a, 1b and 1c are associated with respective corresponding image elements in the FIGS. 2a, 2b and 2c. The elastic transformations are calculated by means of known methods. Depending on which of the known methods is used for the calculation of the elastic transformation, it may be necessary to perform an interpolation method, for example, while utilizing radial base functions, in order to obtain a dense transformation field. The transformation can also be represented by parameters of continuous functions, for example, polynomials. The calculated parameters, or the deformation field, are stored by the arithmetic unit 30 for later use.

Using a selection device 34, the user selects a sub-region of interest of the object to be examined, for example, a tumor, and defines an object, for example, the edge or the surface of the sub-region. The defined object is then visualized in the first images (FIGS. 1a, 1b and 1c) by the display means 32. References 1a, 1b and 1c characterize each time the object defined by a user. The sub-region visualized in each of the FIGS. 1a, 1b and 1c in this case corresponds to the surface of a three-dimensional object, for example, a tumor. Thus, in each of the orthogonal sectional planes the edge of this object is displayed to the user as a defined object superposed on the image. The selection and definition of the object can be simplified by means of deformable models or active contours. The corresponding objects (FIGS. 2a, 2b and 2c) are calculated immediately subsequent to the definition of an object in the first images 1a, 1b and 1c by means of the arithmetic unit 30 and are subsequently displayed while superposed on the second image. The previously calculated elastic transformation is applied to the defined object 1a, 1b, 1c of the first images and the calculation results are reproduced in the second images (FIGS. 2a, 2b and 2c). References 2a, 2b and 2c denote the calculated object corresponding to the object visualizations 1a, 1b, 1c. The calculations are performed preferably in real time so that in the case of a change of the object in the first images, the corresponding changes of the corresponding object in the second images are displayed directly to the relevant user.

In as far as the visualized sub-region, that is, the tumor, has not changed in the time elapsing between the formation of the first images and the second images, the defined object will have the same position and orientation relative to the sub-region in the first and the second images. When the object was defined for example, as the edge of the tumor, the edge of the tumor will be correctly marked in the first and second images. However, when the tumor has changed in the mean time, for example, when it has become smaller as a result of a treatment or larger due to growth, the edge indicated in the second images will no longer correspond to the actual edge of the tumor; this change of the tumor will become immediately apparent to the viewer.

Another possibility consists in that the elastic transformation rule also takes into account changes of the tumor in the rule itself, so that when the elastic transformation is applied to the edge of the tumor defined in the first images, the dimensions of the edge in the second also change, like those of the tumor. When the calculated edge is superposed in the second images, the edge of the tumor is thus correctly displayed again as a mark.

Because of the visualization in accordance with the invention of at least one first and at least one second image of an object to be examined, without the image contents of the first and the second image per se being elastically transformed, image comparison and detection of any changes of the displayed object to be examined are substantially simplified, without introducing errors due to undesired transformations. Artifacts which are due to inaccuracies of the registration method used or due to interpolation of the image contents are thus avoided. The elastic transformation is calculated in advance in accordance with the invention, thus enabling display of the images, or changed images, in real time and hence interactive influencing of the visualization by the viewer, for example, observation of a tumor growth in a time sequence of a number of images. When the method in accordance with the invention is applied, registration errors appear as errors between the morphological information contained in the images and the objects defined by the user. Consequently, errors can be readily detected and interactively corrected. The classification of changes of the pathology is thus supported, but the decision itself is left to the expert. The method in accordance with the invention will thus receive more clinical acceptance in comparison with known approaches.

1. A method of forming different images of an object to be examined, notably medical images of a patient, which method includes the steps of:
displaying at least one first image and one second image,
determining an elastic transformation which associates image elements of the first image with respective image elements of the second image,
defining an object which is superposed on the first image and displayed together with the first image,
determining, using the elastic transformation, an object in the second image which corresponds to the object in the first image,
superposing the corresponding object on the second image, and
displaying the corresponding object together with the second image.

2. A method as claimed in claim 1, characterized in that each time three first and second images are displayed, the three first images and second images representing each time three different, notably orthogonal, sectional planes of the object to be examined.

3. A method as claimed in claim 2, characterized in that an object defined in one of the first images is indicated each time in the other first images.

4. A method as claimed in claim 1, characterized in that the object superposed on the first image represents an edge of a three-dimensional object.

5. A method as claimed in claim 1, characterized in that the object in the first image is defined manually, automatically or semi-automatically.

6. A method as claimed in claim 1, characterized in that the object in the first image is defined by means of model-based segmentation methods.

7. A method as claimed in claim 1, characterized in that the corresponding object in the second image is corrected manually, automatically or semi-automatically.

8. A method as claimed in claim 1, characterized in that the first image and the second image are respective images of the same object to be examined.

9. A method as claimed in claim 1, characterized in that the first image is an image of a standardized model of an object to be examined and the second image is an image of the object to be examined.

10. A device for forming different images of an object to be examined, notably medical images of a patient, which device includes a display means (32) for displaying a first image and a second image, an arithmetic unit (30) for determining an elastic transformation which associates image elements of the first image with respective image elements of the second image, and means (34) for defining an object which is superposed on the first image and displayed together with the first image, characterized in that the arithmetic unit (30) is arranged to determine, using the elastic transformation, an object in the second image which corresponds to the object in the first image, and that the display means (32) is arranged to superpose the corresponding object on the second image and to display the corresponding object together with the second image.

11. A computer program with computer program means for making a computer carry out the steps of the method claimed in claim 1 when the computer program is executed on a computer.
